(19) United States
(12) Patent Application Publication
(10) Pub. No.: US 2025/0199192 A1
(43) Pub. Date: Jun. 19, 2025

(54) TWO-FUNCTION AND MODULAR STRUCTURE THREE-DIMENSIONAL UNDERGROUND SCANNING DEVICE

(71) Applicant: CONRAD MÜHENDISLIK SANAYI VE TICARET LIMITED SIRKETI, MALTEPE (TR)

(72) Inventor: Erol GÖKALP, MALTEPE (TR)

(21) Appl. No.: 18/978,599

(22) Filed: Dec. 12, 2024

(30) Foreign Application Priority Data
Dec. 15, 2023 (TR) 2023/017454

(51) Int. Cl. G01V 3/10

(52) U.S. Cl. CPC G01V 3/10

(57) ABSTRACT

Disclosed is a two-function and modular structure three-dimensional underground scanning device. The device has a two-function and modular device structure having of a magnetic field detector with a magnetic sensor based on the magnetic research method and a metal detector based on the pulse induction system.

### CROSS-REFERENCE TO RELATED APPLICATIONS

Not applicable.

### FIELD OF THE INVENTION

The invention is a two-function and modular structure three-dimensional underground scanning device. The device has a two-function and modular device structure consisting of a magnetic field detector with a magnetic sensor based on the magnetic research method and a metal detector based on the pulse induction system.

### BACKGROUND OF THE INVENTION

Underground scanning devices, or detectors as they are commonly known, are used to detect hidden or buried worthless metals, precious metals such as gold and silver, underground structures, old underground settlements, differences under the ground or the structure of the soil, gaps and underground water. They are also used to ensure that the detected data is transferred to other devices and processed.

When a wire is made into a coil and a current is passed through it, a magnetic field is formed in and around the coil. The magnetic field formed is not visible to the eye. However, the movement of the core inside the coil and the metals brought closer to the coil change the energy storage area of the coil. Magnetic sensors are devices that work on this principle. They detect magnetic changes occurring in their environment. Thus, they produce voltage. Magnetic field detectors with magnetic sensors are used to detect structural differences such as gaps under the ground. However, they cannot be used in precious or non-precious metal searches.

Metal detectors based on the pulse induction system follow a time-controlled oscillator principle that uses alternating current to create a magnetic field in a coil. The magnetic field formed and sent to the ground creates an eddy current and causes a reaction in the buried metal object. The electrical conductivity occurring in the metal object is detected as a disorder, i.e., anomaly, and is reported with acoustic signals. Thus, precious and/or non-precious metals can be detected. However, they cannot be used to detect structural differences such as gaps under the soil.

Currently, either the magnetic field detector with a magnetic sensor based on the magnetic search method or the metal detector based on the pulse induction system are used as two separate underground scanning devices that are independent of each other. In addition, the results obtained are displayed only as numerical data on the screens with a simple interface on the device. The data is displayed as 3D graphics by transferring it to devices such as phones or tablets.

In addition, existing magnetic field detectors with magnetic sensors and metal detectors based on pulse induction systems consist of a single-piece main body. This creates disadvantages in situations such as transportation and storage.

Again, existing products contain only one sensor. This reduces detection sensitivity and can detect objects closer to the surface. As depth increases, the successful detection rate decreases.

### SUMMARY OF THE INVENTION

In order to find solutions to the above mentioned problems, a two-function and modular three-dimensional underground scanning device has been developed.

The purpose of the invention is to obtain a two-function and modular three-dimensional underground scanning device that includes a magnetic field detector with a magnetic sensor based on the magnetic research method and a metal detector based on the pulse induction system.

Another purpose of the invention is to obtain a two-function and modular three-dimensional underground scanning device that can detect objects with greater depth distance by using dual magnetic sensors and increasing the difference between the sensors in software and hardware.

Another purpose of the invention is to obtain a two-function and modular three-dimensional underground scanning device that can be easily transported and/or stored by designing the screen and button sections as foldable and modular.

Another purpose of the invention is to obtain a two-function and modular three-dimensional underground scanning device that can be charged and used with portable power sources (power banks) thanks to the type-c charging input.

### BRIEF DESCRIPTION OF DRAWINGS

The two-function and modular three-dimensional underground scanning device developed to achieve the purpose of the invention is described in detail in the following figures.

FIG. 1 is a front perspective view of the device.

FIG. 2 is a two-dimensional side view of the device, illustrating the folded state of the screen and key section.

FIG. 3 is a rear perspective view exemplifying the modular structure of the device.

### DESCRIPTION OF REFERENCE NUMBERS

1. OLED display,
2. Mainboard,
3. First magnetic sensor,
4. Folding mechanism,
5. Joining part,
6. Second magnetic sensor,
7. Metal detector searching head,
8. Battery and charging cover,
9. Main body,
10. Handle,
11. Magnetic sensor attachment.

### DETAILED DESCRIPTION OF THE INVENTION

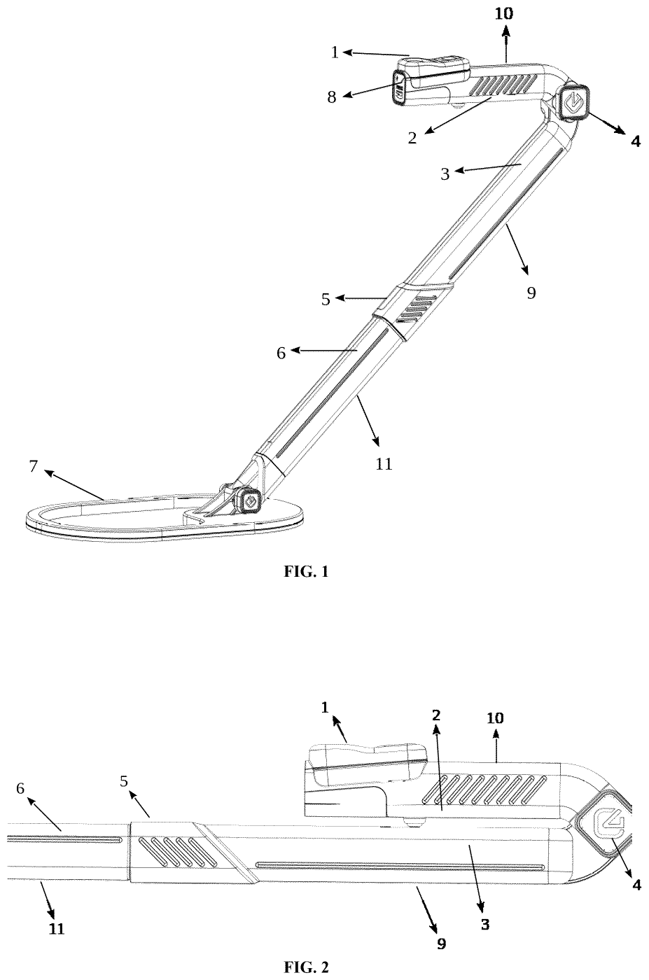

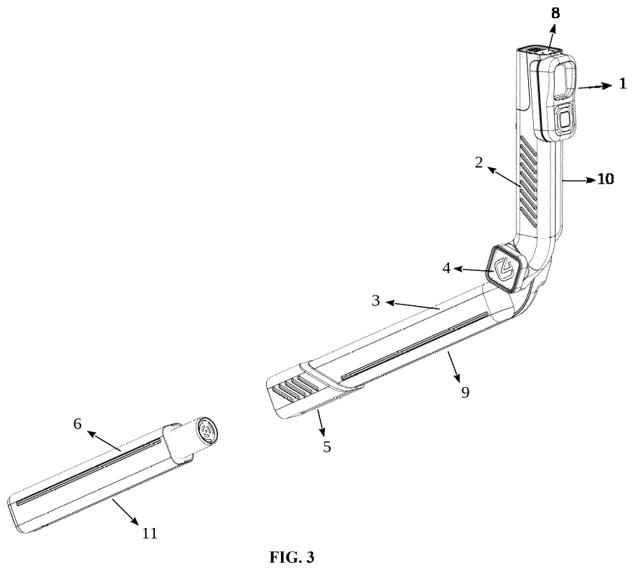

The two-function and modular three-dimensional underground scanning device, which is the subject of the invention, is exemplified in FIG. 1.

Based on the figures and the reference numbers forming the figures, the two-function and modular three-dimensional underground scanning device has a structure consisting of OLED display (1), mainboard (2), first magnetic sensor (3), folding mechanism (4), joining part (5), second magnetic sensor (6), metal detector searching head (7), battery and charging cover (8), main body (9), handle (10) and magnetic sensor attachment (11).

The invention combines the functions of a two-function and modular structure three-dimensional underground scanning device, a magnetic field detector with a magnetic sensor based on the magnetic research method, and a metal detector based on a pulse induction system in a single device, and also has a physically modular device structure.

The OLED display (1) is used for both device management and displaying the results and/or analyses obtained.

The mainboard (2) is the part that contains the electronic components that enable the system to operate. It is located inside the handle (10).

The first magnetic sensor (3) and the second magnetic sensor (6) are two separate sensors in the magnetic sensor system of the detector which is the subject of the invention. The first magnetic sensor (3) is positioned inside the main body (9). The second magnetic sensor (6) is positioned in an external magnetic sensor attachment (11) that can be subsequently added to the main body (9). The difference between both sensors has been increased both in software and hardware, thus increasing the sensitivity level. This arrangement enables a more sensitive level of detection of magnetic variations. Ultimately, it becomes possible to detect objects with greater depth distance.

The folding mechanism (4) connects the main body (9) and the handle (10) and also enables them to be folded. Thus, operations such as transportation and storage become easier.

The joining part (5) enables the main body (9) and the magnetic sensor attachment (11) or the metal detector searching head (7) to be connected together.

Metal detector searching head (7) provides the detection of metals for the part of the detector which is the subject of the invention and is based on the pulse induction system.

A replaceable li-on battery is used as a power source. The charging input is designed in type-c format. Thus, it can be charged with portable power sources (power banks).

The detector, which is subject of the invention consists of separate parts: the main body (9), the magnetic sensor attachment (11) containing the scanning sensor, and the metal detector searching head (7). The magnetic sensor attachment (11) containing the scanning sensor can be attached and removed from the main body (9). In addition, the handle (10) containing the OLED display (1) and the key section can be folded. This modular structure facilitates transportation and/or storage.

Users can conduct more detailed research with a single, two-function, modular structure three-dimensional underground scanning device, which can use two different systems simultaneously. Namely, objects or elements that one system cannot detect can be detected by the other system on the device. For example, while underground gaps cannot be detected by metal detectors, they can be detected by magnetic sensor systems.

1. A two-function and modular structure three-dimensional underground scanning device that combines the functions of a magnetic field detector with a magnetic sensor based on the magnetic research method and a metal detector based on a pulse induction system in a single device and also has a physically modular device structure, comprising an OLED display, a mainboard, a first magnetic sensor, a folding mechanism, a joining part, a second magnetic sensor, a metal detector searching head, a battery and charging cover, a main body, a handle and a magnetic sensor attachment.

2. The two-function and modular structure three-dimensional underground scanning device of claim 1, wherein the OLED display allows both the management of the device and the display of the results and/or analyzes obtained.

3. The two-function and modular structure three-dimensional underground scanning device of claim 1, further comprising a mother board containing electronic components that enable the system to operate.

4. The two-function and modular structure three-dimensional underground scanning device of claim 1, wherein the difference between the first magnetic sensor and the second magnetic sensor has been increased both in software and hardware, in order to enable more sensitive level detection of magnetic variations.

5. The two-function and modular structure three-dimensional underground scanning device of claim 1, wherein the folding mechanism connects the main body and the handle and enables it to be folded.

6. The two-function and modular structure three-dimensional underground scanning device of claim 1, wherein the joining part allows the main body and the magnetic sensor attachment to be connected and combined.

7. The two-function and modular structure three-dimensional underground scanning device of claim 1, wherein the joining part allows the main body and the metal detector searching head to be connected and combined.

8. The two-function and modular structure three-dimensional underground scanning device of claim 1, wherein the metal detector searching head enables the detection of metals for the part of the device that is based on the pulse induction system.

9. The two-function and modular structure three-dimensional underground scanning device of claim 1, further comprising a charging input in type-c format, which allows it to be charged with portable power sources.

10. The two-function and modular structure three-dimensional underground scanning device of claim 1, wherein the main body comprises the first magnetic sensor.

11. The two-function and modular structure three-dimensional underground scanning device of claim 1, wherein the magnetic sensor attachment comprises the second magnetic sensor.

12. The two-function and modular structure three-dimensional underground scanning device of claim 1, wherein the OLED display and the handle cover the key area, the handle being foldable.

13. The two-function and modular structure three-dimensional underground scanning device of claim 1, wherein the main body can be assembled by plugging together when necessary, the magnetic sensor attachment comprising the scanning sensor and the modular structure of the metal detector.
